(19) United States
(12) Patent Application Publication
(10) Pub. No.: US 2004/0240840 A1
(43) Pub. Date: Dec. 2, 2004

(54) System for recording and playback of television signals from a plurality of television channels

(75) Inventors: Daniel Ledermann, Niederscherli (CH); Stefan Trittibach, Gumligen (CH); Urs-Viktor Marti, Bern (CH); Olivier Thyes, Ostermundigen (CH)

Correspondence Address: OBLON, SPIVAK, MCCLELLAND, MAIER & NEUSTADT, P.C., 1940 DUKE STREET, ALEXANDRIA, VA, 22314, US

(73) Assignee: Swisscom AG, Bern (CH)

(21) Appl. No.: 10/791,831

(22) Filed: Mar. 4, 2004

(30) Foreign Application Priority Data
Mar. 4, 2003 (EP) 03100533.3

(51) Int. Cl. H04N 5/76; H04N 5/781

(52) U.S. Cl. 386/46; 386/125

(57) ABSTRACT

Proposed is a system for recording and playback of television signals from a plurality of television channels, which comprises a computer-based controlling central unit, connectible to a telecommunication network, and a plurality of television receivers, connected to the controlling central unit, for receiving the television signals in each case on one of the television channels via cable television networks and/or television antennas for terrestrial television broadcasting or satellite television transmission. The system further comprises coding modules, connected to the television receivers, for coding the received television signals in a digital format. The controlling central unit is set up to receive recording instructions from users via the telecommunication network and to store the television signals, coded in digital format, which have been received on the television channel specified by the stored recording instructions, at a time specified by the stored recording instructions. The system further comprises a playback module for transmitting the television signals, stored in digital format, via the telecommunication network, in each case for playback on a terminal of a respective user. The system enables users to have television signals from a plurality of television channels recorded at the same time without it being necessary for them to have a video recorder at their disposal or to operate a video recorder.

### TECHNICAL FIELD

The present invention relates to a system for recording and playback of television signals from a plurality of television channels. The present invention relates in particular to a system for recording and playback of television signals transmitted on a plurality of television channels via cable television networks, via terrestrial television broadcasting and/or via satellite television transmission.

### BACKGROUND ART

Devices for recording and playback of television signals transmitted via cable television networks, via terrestrial television broadcasting and/or via satellite television transmission are known already for some decades as so-called video recorders or VCRs (Video Cassette Recorders). These conventional video recorders typically have a television receiver and a recording device, connected thereto, programmable by the user. Used as the recording medium in these conventional video recorders are cassettes with magnetic tapes. With the miniaturization of the magnetic hard memory disk and, as a consequence thereof, the enlargement of the storage volume and price reduction, it was only a question of time until video recorders with hard memory disks as a recording medium also came on the market. The video recorders also enable users to record television signals from television transmitters and to play them back time-delayed at a later point in time. If users would like to record television signals from a plurality of television channels at the same time, which is not uncommon especially in families or in apartment-sharing communities with users of different age groups and with different interests, they must have a plurality of video recorders at their disposal, all of which have to be connected to a television signal source and which take up space. Users often find the programming of video recorders to be complicated and inconvenient. The planned recording often fails, for example, because the programmable clock of the video recorder is not set correctly, because another user unintentionally erases or deactivates the programming for a planned recording, because at the decisive moment no playable cassette is inserted, or because some wrong manipulation has been carried out.

Described in the patent application U.S. 2001/0047516 are a method and a system which enable users to obtain from the Internet, in a time-delayed way, at a later point in time desired by the user in each case, digital audio-video data broadcast via the Internet from a network server in streaming mode at a particular non-recurring point in time. According to US 2001/0047516, the users can select the digital audio-video data which they would like to obtain in a time-delayed way in that they select events announced in the Internet on a server, provided therefor, on the occasion of which the desired digital-audio data will be broadcast via the Internet. The system according to US 2001/0047516 makes possible the time-delayed transmission of digital audio-video data, broadcast in streaming mode via the Internet; it is not suitable, however, for the recording and playback of television signals from a plurality of television channels.

### DISCLOSURE OF INVENTION

It is an object of the present invention to propose a new system for recording and playback of television signals which does not have the drawbacks of the state of the art and which is suitable in particular for recording and playback of television signals from a plurality of television channels.

These objects are achieved according to the present invention through the elements of the independent claims. Further preferred embodiments follow moreover from the dependent claims and from the specification.

The above-mentioned objects are achieved according to the present invention in particular through a system for recording and playback of television signals from a plurality of television channels, which system comprises a computer-based controlling central unit, connectible to a telecommunication network, a plurality of television receivers, connected to the controlling central unit, for receiving television signals in each case on one of the television channels, one or more coding modules, connected to the television receivers, for coding the received television signals in a digital format, and a playback module for transmitting television signals, coded in digital format, over the telecommunication network to a terminal in each case for playback. The television receivers are preferably set up to receive digital and/or analog television signals via cable television networks and/or via television antennas for terrestrial television broadcasting or satellite television transmission. The controlling central unit and the playback module are each implemented, for example, on different computers connected to one another, the controlling central unit and/or the playback module comprising memories for storing the television signals coded in digital format.

The above-mentioned objects are achieved according to the present invention in particular in that the controlling central unit is set up to receive recording instructions from users via the telecommunication network, to store the received recording instructions, assigned in each case to a user identification for the respective user, and to store the television signals, coded in digital format, which have been received on the television channel specified by the stored recording instructions, at a time specified by the stored recording instructions, assigned in each case to the user identification to which the respective stored recording instructions are assigned, and the playback module is set up for transmitting the television signals stored in digital format via the telecommunication network, in each case for playback on a terminal of the user, who is identified by the user identification assigned to the respective stored television signals. The advantage of the system according to the invention is in particular that a multiplicity of users can have television signals from a plurality of television channels recorded at the same time without their having to have a video recorder at their disposal themselves. The controlling central unit enables the users to record television signals of desired telecasts in a simple and reliable way without the users having to operate and program a video recorder, without the users having to check the state of a video recorder, without the users having to set a programmable clock of a video recorder, and without the users having to provide recording media. The recording and playback of the television signals takes place furthermore independently of place, i.e. a mobile user can transmit recording instructions from any first location and have the playback of the television signals, stored in digital format, carried out at any second location.

The controlling central unit is preferably set up, in accordance with the stored recording instructions, to transmit in each case control signals to one of the connected television receivers to activate the respective television receiver and/or to select a television channel on the respective receiver. Through the activation, or respectively deactivation, of the television receiver by means of control signals and/or through the selection of a television channel on the respective television receiver by means of control signals, the individual television receivers can be employed efficiently, according to need, within a pool of a plurality of television receivers. This means that a deactivated, available television receiver is only activated and set on a particular television channel if this is necessary according to the stored recording instructions.

The telecommunication network is preferably a network based on Internet protocol, and the playback module is set up to transmit the television signals, stored in digital format, in streaming mode via the telecommunication network, in particular via the Internet, to the terminals of the users. On the one hand, through the use of Internet protocol, the recording instructions can be entered everywhere by means of conventional, mobile or fixed-installed, Internet-based terminals, and, on the other hand, the centrally recorded television signals can be obtained worldwide. Though the use of streaming mode and through the use of playback modules suitable therefor at the terminals, the user can be barred from unlawful local copying of obtained digital television signals.

Preferably, the controlling central unit is set up to encrypt the television signals, coded in digital format, with a cryptographic key in each case, prior to their storage, and the system comprises an access control module for generating access rights to the television signals, stored in digital format, and for transmitting generated access rights, comprising the respective cryptographic keys, via the telecommunication network to authorized users, and the playback module is set up to receive access rights from users via the telecommunication network and, in accordance with the received access rights, to transmit the encrypted television signals, stored in digital format, to the respect user. The encryption of the television signals, coded in digital format, and the transmission, contingent upon access rights, of encrypted television signals, coded in digital format, makes possible a protected access control of the television signals, stored in digital format, it being possible in particular for the transmission of the access rights to take place in a way subject to fees, against billing, and, for instance, in a way entitling the user to one-time or multiple dispensing of the television signals, stored in digital format.

In an embodiment variant, the playback module is set up to transmit the television signals, stored in digital format, over the telecommunication network to the terminal in a way dependent upon quality parameters of the terminal of the respective user in each case. This has the advantage that the format and the quality of the television signals, coded in digital format, can be adapted to the characteristics of the terminal, for instance display dimensions of the terminal or the bandwidth of the communication channel of the terminal.

Preferably, the controlling central unit includes stored television program information, and the controlling central unit is set up to receive from users as recording instructions via the telecommunication network identification data for telecasts and, in accordance with the received identification data, to store recording instructions, based on the television program information, with indications about television channel and telecast identification and/or starting time/ending time or respectively duration. Deriving recording instructions on the basis of received identification data for telecasts and stored television program information has the advantage that users do not need to determine indications about television channel, nor starting time/ending time or respectively duration, but instead only have to indicate identification data for telecasts, such as a title or a number, for instance from a list, to specify a telecast to be recorded.

In an embodiment variant, after successful storing of the television signals, coded in digital format, which have been recorded in accordance with the stored recording instructions, the controlling central unit is set up to transmit an electronic ready message via the telecommunication network to the terminal of the user whose user identification is assigned to the respective recording instructions. Through the automatic notification, unnecessary queries at the controlling central unit by the user about the status of the recordings, ordered by way of recording instructions, become superfluous.

In an embodiment variant, the controlling central unit is set up to erase automatically television signals, stored in digital format, after a defined period of time after their storage, and the controlling central unit is set up to transmit automatically, in each case before the automatic erasing, an electronic warning signal via the telecommunication network to the terminal of the user whose user identification is assigned to the respective stored television signals. Through the automatic erasing of television signals stored in digital format, storage resources in the system can be freed up and the blocking of the storage resources by “old” television signals stored in digital format can be prevented. By means of the automatic warning message, the number of queries at the controlling central unit by the user relating to the expiration date of the television signals stored in digital format can be reduced.

Preferably, the controlling central unit is set up to store only once in each case, jointly assigned to the user identifications of the respective plurality of users, television signals, coded in digital format, which have been received at a time and on a television channel which are identified through consistent recording instructions from a plurality of users. By television signals, stored in digital format, being stored only once even for a plurality of users, storage resources in the system can be saved.

### BRIEF DESCRIPTION OF DRAWINGS

An embodiment of the present invention will be described in the following with reference to an example. The example of the embodiment will be illustrated by the following sole FIGURE:

FIG. 1 shows a block diagram illustrating schematically a system for recording and playback of television signals from a plurality of television channels, which is connected, on the one hand, to different sources of television signals and, on the other hand, to different terminals via a telecommunication network.

### MODES FOR CARRYING OUT THE INVENTION

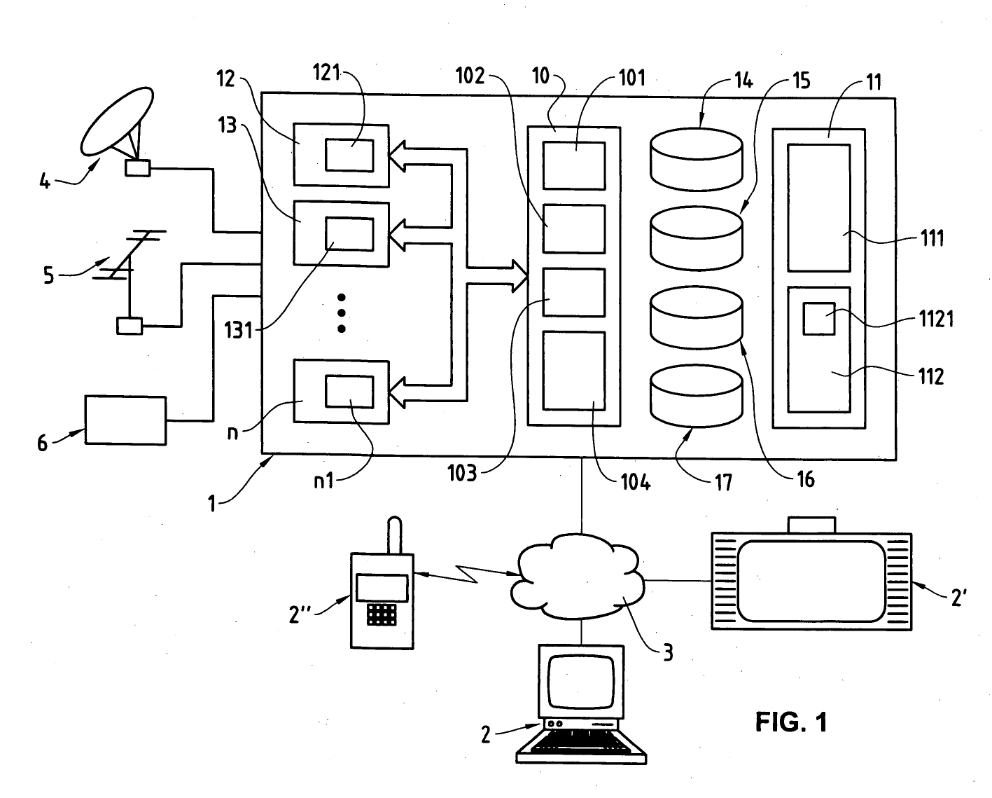

In FIG. 1, the reference numeral 1 refers to a system for recording and playback of television signals from a plurality of television channels. The system comprises a plurality of television receivers 12, 13, . . . , n for receiving digital television signals, e.g. DVB (Digital Video Broadcasting), and/or analog television signals, e.g. PAL (Phase Alternating Line), SECAM (Sequential Color Memory) or NTSC (National Television Standards Committee), each on a television channel. Via the television receivers 12, 13, . . . , n, the system 1 is connected to various sources of television signals, in particular to a television antenna for satellite television transmission 4, i.e. to a dish antenna, to a television antenna for terrestrial television broadcasting 5, and to a cable television network 6.

The television receivers 12, 13, . . . , n each preferably comprise a coding module 121, 131, . . . , n1 for coding the received television signals in a digital format, for example MPEG2 (Moving Picture Expert Group 2), MPEG4 (Moving Picture Expert Group 4), DV (Digital Video) or a manufacturer-specific digital format from companies such as Real™ or Microsoft™. The coding modules 121, 131, . . . , n1 can also be implemented separately from the television receivers 12, 13, . . . , n and connected to them. A television receiver 12, 13, . . . , n can also be assigned a plurality of coding modules 121, 131, . . . , n1, or received television signals from a plurality of television receivers 12, 13, . . . , n can be coded by a common coding module 121, 131, . . . , n1.

The television receivers 12, 13, . . . , n, respectively the coding modules 121, 131, . . . , n1, are connected to the computer-based controlling central unit 10. The controlling central unit 10 comprises one computer or a plurality of computers connected together. The controlling central unit 10 further comprises a communication module for connecting the system 1 to the telecommunication network 3.

The telecommunication network 3 is based preferably on Internet protocol (IP), and is connected to the worldwide Internet and/or to one or more intranets. The telecommunication network 3 makes possible in particular the connection of the system 1 to terminals such as personal computers (PC) 2 or television sets with corresponding set-top boxes 2′. The telecommunication network further comprises mobile radio networks, for example GSM—(Global System for Mobile Communication), UMTS—(Universal Mobile Telecommunication System) or other, e.g. satellite-based, mobile radio networks, for connection of the systems 1 to mobile terminals 2″, such as mobile radio telephones, laptop or PDA computers (Personal Digital Assistant).

The controlling central unit 10 comprises a plurality of programmed software modules, the functions of which will be described in the following.

By means of the instruction module 101, the controlling central unit 10 receives recording instructions from users of the terminals 2, 2′, 2″ via the telecommunication network 3. The recording instructions comprise identification data for telecasts which are supposed to be recorded by the system 1 for the user concerned. The identification data comprise, for example, title or code values for telecasts entered by the user or selected from a television program list or list of telecasts of the instruction module 101. The television program or telecast lists are generated on the basis of stored television program information 15. The identification data are determined, for instance, by means of a so-called electronic programming guide (EPG). Moreover during the generation of the television program lists or telecast lists, user-specific profiles, from a user database 14, with indications of interests and/or data about the historic user behavior can also be taken into consideration. On the basis of the received identification data and the television program information, the instruction module 101 determines indications about television channel and starting time/ending time or respectively duration of telecasts which are to be recorded for the user. The users can also transmit recording instructions to the controlling central unit 10 with indications about television channel and starting time/ending time or respectively duration of telecasts. Recording instructions can also comprise data for recording of series, for example for recording all the episodes of a series, for recording a series or a defined time segment periodically until revoked, or for recording a particular number of times. The recording instructions are stored in a data store of the system 10 designated by the reference numeral 16. The recording instructions are stored assigned in each case to a user identification for the user concerned from whom the recording instructions were received. The user identification is transmitted, for example, from the user along with the recording instructions to the controlling central unit 10, it is taken from the user database 14 on the basis of identification data for the user, and/or it is determined by the controlling central unit 10 based on the communication with the terminal of the user 2, 2′, 2″, e.g. based on a network address, a call number or an IMSI (International Mobile Subscriber Identity).

In accordance with the recording instructions stored in the data store 16, the recording module 102 of the controlling central unit 10 generates control signals for activation of an available television receiver 12, 13, . . . , n and/or for selection of a television channel on the available activated television receiver 12, 13, . . . , n. One skilled in the art will understand that the television receiver 12, 13, . . . , n can also be activated permanently or can be assigned in a fixed way to a defined television channel. Depending upon embodiment variant, coding modules 121, 131, . . . , n1 will also be activated. The recording module 102 stores in the recording memory 17 the television signals coded in digital format which are received at the time identified through the respective stored recording instructions, on the television channel identified through the respective stored recording instructions. The television signals coded in digital format are stored assigned to the user identifications which are assigned to the respective stored recording instructions; the television signals coded in digital format are thereby stored in the recording memory 17 just once for a plurality of users.

With the aid of the encryption module 103, the television signals coded in digital format are encrypted with a cryptographic key prior to storing.

After successful encryption and storage of the television signals coded in digital format, the recording module 102 transmits an electronic ready message via the telecommunication network 3 to the terminals 2, 2′, 2″ of the users concerned whose user identifications are assigned to the stored recording instructions concerned. The ready message is, for instance, an e-mail or an SMS message (Short Message Service System).

The controlling central unit 10 has moreover an erasing module 104, which automatically erases the television signals stored in digital format after a defined period of time after their storage, for example after one month. Prior to this expiration date the erasing module 104 transmits an electronic warning message, for instance an e-mail or an SMS message, via the telecommunication network 3 to the terminals 2, 2′, 2″ of the users concerned. The users concerned can obtain the television signals stored in digital format from the system 1 before their deletion, or prolong the expiration date, for instance in exchange for a fee.

The system comprises a playback module 11 for transmitting the television signals stored in digital format over the telecommunication network 3 for playback on a terminal 2, 2′, 2″ of a user, who is identified through the user identification assigned to the respective television signals stored in digital format. The playback module 11 is implemented together with the controlling central unit 10 on a common computer or on one or more separate computers.

The playback module 11 comprises a plurality of programmed software modules, the functions of which will be described in the following.

By means of the access control module 111, the playback module 11 generates access rights for the television signals stored in digital format. The access control module 111 transmits the generated access rights, comprising in each case the cryptographic key for decrypting the respective television signals coded in digital format, over the telecommunication network 3 to the terminals 2, 2′, 2″ of authorized users. Fees can thereby be charged and billed to the user concerned. The access rights are transmitted, for example, to the authorized users in the form of digital certificates, which are electronically signed. Access rights are transmitted only to those users who have asked for the recording of the television signals stored in digital format and to whom the fees due could be billed, or whose creditworthiness is ensured, for instance. For billing fees due, the access control module 111 is preferably connected to a billing module suitable therefor. The functions of the access control module 111 are designed according to so-called digital rights management (DRM).

If a user would like to obtain from the system 1 the television signals stored in digital format and have them shown on his terminal 2, 2′, 2″, he transmits a corresponding request with the respective access right and an identification of the television signals stored in digital format to the system 1, where it will be received by the playback module 11 and further processed. Such a request is automatically generated by a software module in his terminal 2, 2′, 2″, for example, when the user selects in a list, which is displayed on his terminal 2, 2′, 2″, a reference to the desired television signals stored in digital format. Depending upon access right, a user is entitled to one-time or multiple dispensing of the television signals stored in digital format.

By means of the transmission module 112, the encrypted television signals stored in digital format are transmitted over the telecommunication network 3 for decryption and playback to the terminal 2, 2′, 2″ of the user concerned. The transmission for playback takes place using flow control, preferably in streaming mode. The transmission for playback can also take place in so-called download mode. In streaming mode data elements of the encrypted television signals, stored in digital format, are transmitted in chronological sequence to the terminals 2, 2′, 2″, where they are received by a software module continuously, are temporarily stored in a buffer memory, are decrypted with the respective cryptographic key, and are reproduced optically and visually. The streaming mode makes possible in each case a one-time playback of the television signals coded in digital format on the terminals 2, 2′, 2″, without the complete file with the television signals stored in digital format being stored in the terminals 2, 2′, 2″. Not only can the already mentioned awarding of access rights to a user and/or fees for recordings made be billed, by means of a billing module, compensation can also be credited to the respective legal owner for their copyrights with each dispensing of the television signals, stored in digital format.

It should be stated here moreover that the dispensing and transmission of the television signals, stored in digital format, is possible not merely after complete recording of the entire telecast, but the television signals, already stored in digital format, can also be transmitted in an ongoing way for playback to the terminal 2, 2′, 2″ of the user concerned, upon request, in so-called time-shift mode also during a recording.

Before transmission of the television signals, stored in digital format, to the terminals 2, 2′, 2″, it is determined through the software function designated by the reference numeral 1121, in which quality and/or in which format the television signals, stored in digital format, should be transmitted to the terminals 2, 2′, 2″. Thereby taken into consideration are quality parameters of the terminal of the user concerned. For example, taken into account are terminal parameters for the terminal 2, 2′, 2″ of the respective user, for instance the display dimensions and/or resolution, the type of device or the transmission capacity or respectively transmission speed of the respective terminal 2, 2′ 2″ over the telecommunication network 3. Different transmission qualities and/or formats can also be requested by the terminal 2, 2′ 2″, or respectively by the user, together with the request for obtaining the television signals, stored in digital format, by the playback module 11. It should be pointed out here that it can also be provided for that a user can also specify the recording quality, in addition to the playback quality; for example, the television signals can be coded and stored in such a way that the picture quality corresponds during playback to the respective television quality, VHS quality (Video Home System) or DVD quality (Digital Versatile Disk).

One skilled in the art will understand that different technical architectures are possible, according to which the different modules and data stores of the system 1 can be implemented on one or more computers. It should be mentioned here in particular that the recording memory 17 for storing the television signals coded in digital format and the user database 14 can be implemented together with the controlling central unit 10 on a computer and/or together with the playback module 11 on a computer, or can be implemented on one or more separate computers accessible to the controlling central unit 10 and the playback module 11.

Finally it is should be noted that one skilled in the art will understand that functional modules which have been described here as software modules can also be implemented completely or partly as hardware.

### List of Reference Numerals

1 system for recording and playback of television signals from a plurality of television channels

2, 2′, 2″ terminals

3 telecommunication network

4 television antenna for satellite television transmission

5 television antenna for terrestrial television broadcasting

6 cable television network

10 computer-based controlling central unit

11 playback module

12, 13, . . . , n television receivers

14 user database

15 stored television program information

16 data memory for recording instructions

17 recording memory

101 instructions module

102 recording module

103 encryption module

104 erasing module

111 access control module

112 transmission module

121, 131, . . . , n1 coding module

1121 software function for determining transmission quality

1. A system for recording and playback of television signals from a plurality of television channels, comprising:
a computer-based controlling central unit, connectible to a telecommunication network,
a plurality of television receivers, connected to the controlling central unit, for receiving television signals in each case on one of the television channels,
one or more coding modules, connected to the television receivers, for coding the received television signals in a digital format,
the controlling central unit being set up to receive recording instructions from users via the telecommunication network, to store the received recording instructions, assigned in each case to a user identification for the respective user, and to store the television signals, coded in digital format, which have been received on the television channel specified by the stored recording instructions, at a time specified by the stored recording instructions, assigned in each case to the user identification to which the respective stored recording instructions are assigned, and
a playback module for transmitting the television signals stored in digital format via the telecommunication network, in each case for playback on a terminal of the user, who is identified by the user identification assigned to the respective stored television signals.

2. The system according to claim 1, wherein the controlling central unit is set up to transmit, in accordance with the stored recording instructions, control signals in each case to one of the connected television receivers for activation of the respective television receiver and/or for selection of a television channel on the respective television receiver.

3. The system according to one of the claims 1 or 2, wherein the telecommunication network is a network based on Internet protocol, in that the playback module is set up to transmit the television signals, stored in digital format, in streaming mode via the telecommunication network to the terminal of the user.

4. The system according to one of the claims 1 to 3, wherein the controlling central unit is set up to encrypt the television signals, coded in digital format, with a cryptographic key in each case, prior to their storage, in that the system comprises an access control module for generating access rights to the television signals, stored in digital format, and for transmitting generated access rights, comprising the respective cryptographic keys, via the telecommunication network to authorized users, and in that the playback module is set up to receive access rights from users via the telecommunication network and, in accordance with the received access rights, to transmit the encrypted television signals, stored in digital format, to the respect user.

5. The system according to one of the claims 1 to 4, wherein the playback module is set up to transmit the television signals, stored in digital format, via the telecommunication network to the terminal in each case depending upon quality parameters of the terminal of the respective user.

6. The system according to one of the claims 1 to 5, wherein the controlling central unit includes stored television program information, and in that the controlling central unit is set up to receive from users as recording instructions via the telecommunication network identification data for telecasts and, in accordance with the received identification data, to store recording instructions, based on the stored television program information, with indications about television channel and telecast identification and/or starting time/ending time or respectively duration.

7. The system according to one of the claims 1 to 6, wherein the controlling central unit is set up to transmit, after successful storing of the television signals, coded in digital format, in accordance with the stored recording instructions, an electronic ready message via the telecommunication network to the terminal of the user whose user identification is assigned to the respective recording instructions.

8. The system according to one of the claims 1 to 7, wherein the controlling central unit is set up to erase automatically television signals, stored in digital format, after a defined period of time after their storage, and in that the controlling central unit is set up to transmit automatically, in each case before the automatic erasing, an electronic warning signal via the telecommunication network to the terminal of the user whose user identification is assigned to the respective stored television signals.

9. The system according to one of the claims 1 to 8, wherein the controlling central unit is set up to store only once, jointly assigned to the user identifications of the respective plurality of users, television signals, coded in digital format, which have been received at a time and on a television channel which are identified through consistent recording instructions from a plurality of users.

10. The system according to one of the claims 1 to 9, wherein the television receivers are set up to receive digital and/or analog television signals via cable television networks and/or via television antennas for terrestrial television broadcasting or satellite television transmission, and in that the controlling central unit and the playback module are each implemented on different computers connected to one another, the controlling central unit and/or the playback unit including memories for storing the television signals coded in digital format.
